(19) United States
(12) Patent Application Publication
(10) Pub. No.: US 2013/0258814 A1
(43) Pub. Date: Oct. 3, 2013

(54) Ultrasound System and Method of Manufacture

(71) Applicant: SONETICS ULTRASOUND, INC., Ann Arbor, MI (US)

(72) Inventors: Collin A. Rich, Ypsilanti, MI (US); David F. Lemmerhirt, Ann Arbor, MI (US)

(73) Assignee: Sonetics Ultrasound, Inc., Ann Arbor, MI (US)

(21) Appl. No.: 13/854,824

(22) Filed: Apr. 1, 2013

Related U.S. Application Data
(60) Provisional application No. 61/618,209, filed on Mar. 30, 2012.

(51) Int. Cl. H04R 17/00; H04R 31/00

(52) U.S. Cl. CPC H04R 17/00; H04R 31/00
USPC 367/157; 29/594

(57) ABSTRACT

An ultrasound system and a method of manufacturing an ultrasound system comprising a base comprising a bore; a prismatic segment, coupled to the base, that defines a set of surfaces surrounding the bore; a set of ultrasound transducer panels configured to emit ultrasound signals in a radial direction, each ultrasound transducer panel in the set of ultrasound transducer panels coupled to at least one surface of the set of surfaces, and an interconnect coupling a first ultrasound transducer panel in the set of ultrasound transducer panels to a second ultrasound transducer panel in the set of ultrasound transducer panels, wherein the interconnect facilitates coupling of the first ultrasound transducer panel and the second ultrasound transducer panel to the prismatic segment.

### CROSS-REFERENCE TO RELATED APPLICATIONS

This application claims the benefit of U.S. Provisional Application Ser. No. 61/618,209, filed on 30 Mar. 2012, which is incorporated herein in its entirety by this reference.

### TECHNICAL FIELD

This invention relates generally to the ultrasound field, and more specifically to a new and useful ultrasound system.

### BRIEF DESCRIPTION OF THE FIGURES

FIG. 1 is a schematic of an embodiment of the system;

FIGS. 2A and 2B are cross-sectional schematics of variations of an embodiment of the system embodiment taken along line 2 in FIG. 1;

FIGS. 3A-3F are schematics of variations of the ultrasound transducer panels in an embodiment of the system;

FIGS. 4A and 4B are perspective and cross-section views, respectively, of a schematic of a variation of an embodiment of the system;

FIGS. 5A and 5B are perspective and cross-section views, respectively, of a schematic of a variation of an embodiment of the system;

FIGS. 6A and 6B are perspective and cross-section views, respectively, of a schematic of a variation of an embodiment of the system;

FIGS. 7A and 7B are perspective and cross-section views, respectively, of a schematic of a variation of an embodiment of the system;

FIG. 8 is a flowchart of an embodiment of the method;

FIGS. 9A-9E are schematics of variations of an embodiment of the method; and

FIG. 10 is a flowchart of a variation of an embodiment of the method.

### DESCRIPTION OF THE PREFERRED EMBODIMENTS

The following description of preferred embodiments of the invention is not intended to limit the invention to these preferred embodiments, but rather to enable any person skilled in the art to make and use this invention.

1. Ultrasound System

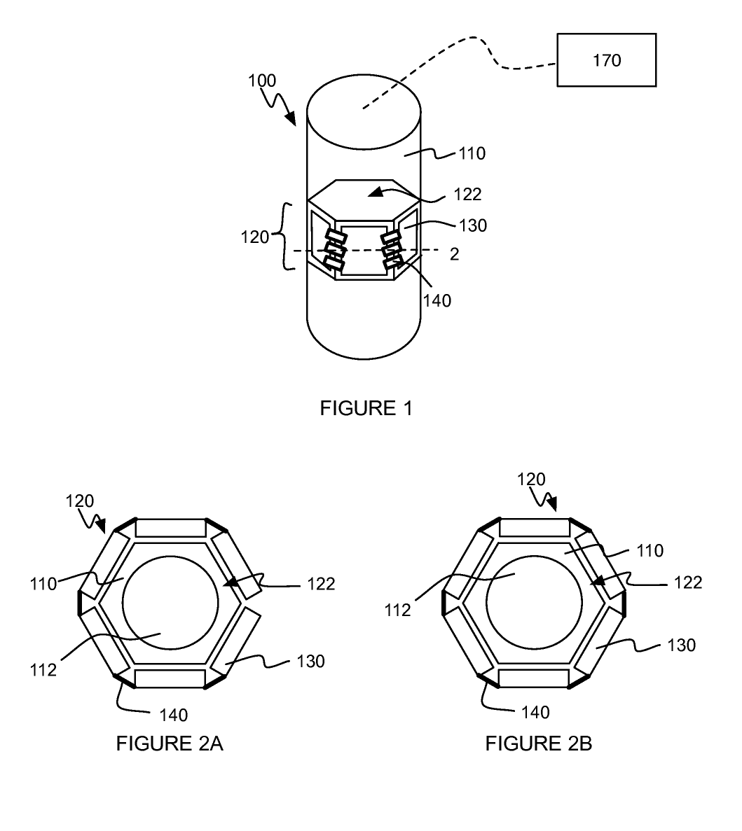

As shown in FIG. 1, an embodiment of an ultrasound system 100 includes: a base 110; a prismatic segment 120, coupled to the base, that defines a set of surfaces 122; and a set of ultrasound transducer panels 130, each ultrasound transducer panel coupled to at least one respective surface 122 of the prismatic segment 120. The system 100 can further include at least one interconnect 140 coupled between two ultrasound transducer panels 130 configured to electrically and/or physically connect two ultrasound transducer panels 130. The system 100 can also further include a tracking module 170 that enables a location of the system 100 to be tracked. As such, the system 100 can be configured to couple to or to receive a guide wire (e.g., within a bore of the system 100) that allows the system 100 to be guided and/or tracked during use. The system 100 can also be placed within a sheath (e.g., covering, catheter) that functions to protect the system 100 during use.

In one specific application, the system 100 can be placed within a sheath and passed through a lumen of a fluid vessel. In the specific application, the system 100 does not directly contact the fluid or the fluid vessel, and is configured to emit ultrasound signals outwardly in a radial direction (using the ultrasound transducer panels 130) in order to generate ultrasound data based on ultrasound signals reflected from the interior of the fluid vessel, from structures within the vessel walls, and from material or tissue outside the vessel. In another specific application, the system 100 may substantially fill a fluid vessel while allowing a fluid from the fluid vessel to pass through the bore 112 of the system 100. In this specific application, the system 100 is configured to emit ultrasound signals radially (outward and inward) using the ultrasound transducer panels 130, in order to generate ultrasound data related to flow of the fluid through the bore 112 and to generate ultrasound data related to the surface of the fluid vessel (and/or objects external to the fluid vessel or structures within the vessel wall). In yet another specific application, the system 100 may be passed through a vessel and used to generate ultrasound data along the length of the vessel, which is partially enabled by a tracking module 170. In any of the examples, the vessel may be a biological fluid vessel (e.g., blood vessel) or any other suitable fluid vessel.

The system 100 preferably comprises ultrasound transducer panels 130 that are approximately planar, such that each planar ultrasound transducer panel 130 can couple to a planar surface 122 at multiple points to enable a secure and stable face-to-face coupling. The ultrasound transducer panels 130 preferably form a polygonal ultrasound system that approximates a convex (and additionally or alternatively concave) ultrasound transducer array, such that the system 100 is configured to emit and/or receive acoustic signals in a radial direction. Alternatively, the system 100 may comprise ultrasound transducer panels 130 having any suitable surface geometry that allows conformation of an ultrasound transducer panel 130 to a surface 122 of the base no for coupling of the ultrasound transducer panels 130 to the base 110. In an example, an ultrasound transducer panel 130 may have a convex surface that conforms to a concave surface of the base 110, or the ultrasound transducer panel 130 may have a concave surface that conforms to a convex surface of the base 110. In another example of the alternative embodiment, an ultrasound transducer panel 130 may have a recess or a protrusion configured to couple to a corresponding protrusion or a recess of the base 110. Thus, neither the ultrasound transducer panel 130 nor the base 110 is limited to having a polygonal cross-section. The system 100 may therefore be polygonal or non-polygonal, depending upon the configurations of the base 100 and/or the ultrasound transducer panels 130.

The base 110 of the system 100 functions to provide a support for the ultrasound transducer panels 130. The base may be columnar and may be defined by a longitudinal axis, or may comprise any other suitable geometry. Furthermore, the base 110 may be composed of a conducting or an insulating material, and preferably does not obstruct transmission of acoustic signals from the ultrasound transducer panels 130. Alternatively, the base may obstruct transmission of acoustic signals, in order to limit transmission of acoustic signals from the system 100 in at least one direction. The material of the base 110 may be thermally bondable to other materials in order to facilitate thermal bonding processes to form a physically coextensive structure. The material of the base 110 may additionally or alternatively be machinable, etchable, lithographically defineable, photodefinable, or processable by any other suitable method to facilitate fabrication of the base 110 and/or coupling of the base 110 to other elements.

As shown in FIGS. 2A and 2B, the base 110 of an embodiment of the system 100 can further include a bore 112 or lumen located within the base 110 and passing along a longitudinal axis of the base 110. The bore 112 may or may not be accessible through the prismatic segment 120 and/or the set of surfaces 122. The base 110 preferably includes one bore 112 approximately concentric with the base 110, but can alternatively include any suitable number of bores of any suitable shape in any suitable location. Alternatively, the base 110 can be substantially solid or can comprise a set of bores 112 that are not contiguous within the base 110. The bore 112 can, for example, function to hold electrical components or any suitable components of the system 100, or to provide means for mounting or positioning the ultrasound array. In one specific example, the bore is configured to receive a catheter tube and/or catheter guide wire (e.g., having an external diameter equal to or less than the internal diameter of the bore 112). In the specific example, the catheter tube and/or catheter guide wire can be used to position, maneuver, or otherwise manipulate the polygonal ultrasound system 100 into a vessel, such that the system 100 can generate ultrasound data related to the vessel. In another specific example, the bore 112 may be configured to receive a fluid, such that the system can generate ultrasound data related to the fluid within the bore 112. However, the bore 112 can be of any suitable size or geometric shape, and can have any suitable function.

As shown in FIGS. 2A, 2B, 4B, 5B, 6B, and 7B, the base 110 preferably comprises a prismatic segment 120 that defines a set of surfaces 122. The prismatic segment 120 preferably defines a polygonal cross-section approximating a convex and/or concave shape. The prismatic segment 120 preferably has a cross-section in the shape of a regular hexagon or dodecagon, but can alternatively have a cross-section in the shape of a regular or irregular polygon of any suitable number of sides. Alternatively, the prismatic segment may comprise or define a non-planar surface, such that the prismatic segment 120 has a non-polygonal cross-section. The prismatic segment 120 may extend along only a portion of the base 110. Additionally, the base 110 can include one or more prismatic segments, and one or more non-prismatic segments. The prismatic segment 120 can be located at an end of the base 110, centrally in the base 110 between two ends of the base, or in any other suitable portion of the base 110. The non-prismatic segment (or segments) is preferably cylindrical with an approximately circular cross-section, but can alternatively have a cross-section that is ellipsoidal, polygonal of any suitable number of sides, non-polygonal, open, closed, or any suitable shape. Alternatively, the prismatic segment 120 may be slightly shorter than the base 110, or may extend along the entire length of height of the base 110, an example of which is shown in FIG. 5A.

As shown in FIGS. 2A and 2B, in a first variation of the prismatic segment 120 of the system 100, the prismatic segment 120 includes surfaces 122 that are solid, substantially planar facet surfaces. In the first variation, the prismatic segment 120 may additionally or alternatively include a non-planar surface. In this variation, a cross-section of the prismatic segment 120 may include a complete outline of a polygon, or may be non-polygonal. Planar facets of the prismatic segment 120 are preferably formed by milling, grinding, polishing, etching, and/or otherwise removing material to create a particular shape of the prismatic segment 120. Alternatively, the prismatic segment 120 can be formed by injection molding or other extrusion process(es), casting, 3D-printing, lithography, photodefining, or any suitable manufacturing process. The manufacturing process can depend on, for example, the specific material or materials included in the base 110.

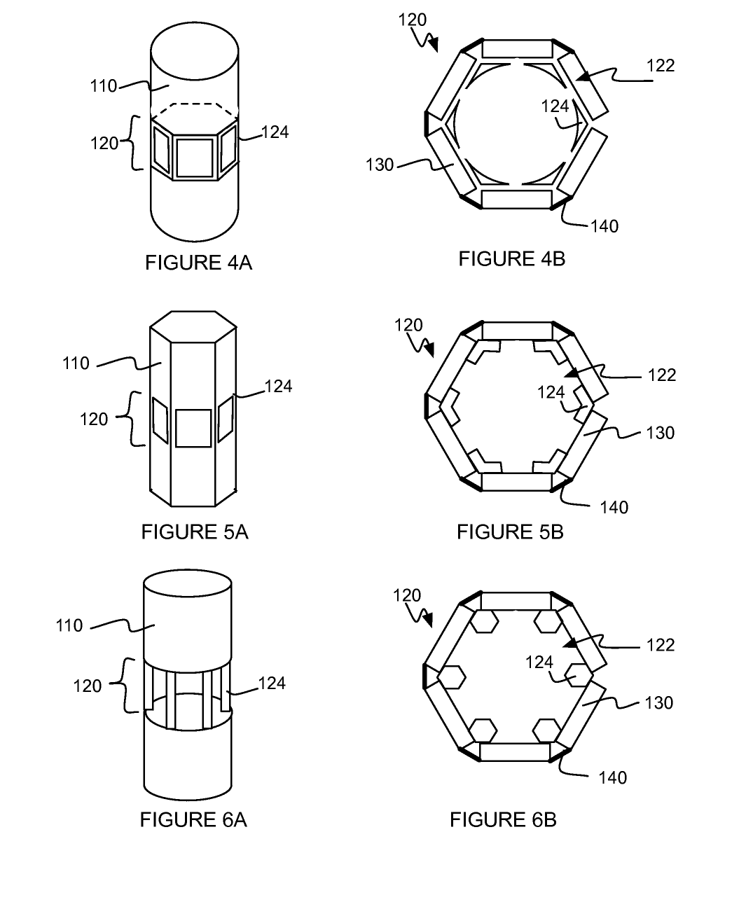

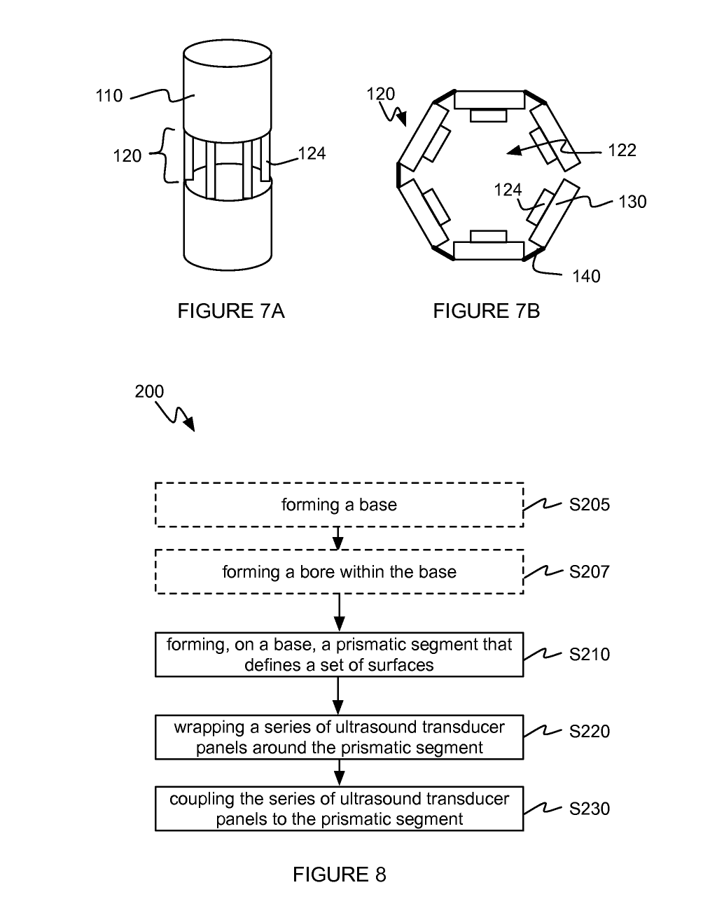

As shown in FIGS. 4A-7B, in a second variation of the prismatic segment 120 of the system 100, the prismatic segment 120 includes a set of surfaces 122 that are defined by a framework of struts 124. In this variation, a transverse cross-section of the prismatic segment 120 thus either includes a partial outline of a polygon, or a cross-sectional view of the struts 124 may define vertices of a polygon. As shown in FIGS. 4A, 4B, 5A, 5B, 6A, and 6B, one or more struts 124 can be located at a vertex of the prismatic segment 120. For example, the struts 124 can include at least two planar surfaces arranged at an angle corresponding to the vertex angle of the prismatic segment 120 (e.g., approximately 120° angled strut surfaces in a hexagonal prismatic segment). However, as shown in FIGS. 7A and 7B, the one or more struts 124 can additionally or alternatively define an approximately planar surface located on a surface 122 of the prismatic segment 120. One or more struts 124 may additionally or alternatively define a non-planar surface located at any appropriate location, such that the strut conforms to a corresponding surface of at least one ultrasound transducer panel 130.

In one variation of a system 100 comprising a framework of struts 124, the struts 124 are integrated with the base 110 (in either a unitary or physically coextensive manner), and defined by removing material (e.g., milling, boring a central circular lumen that is at least large enough to be inscribed in the prismatic segment 120), direct formation through manufacturing (e.g., injection molding or other extrusion process, 3-D printing, photolithography, etching), or in any suitable manner. In another version of the system 100, the struts 124 are separate structures coupled to the base 110, such as by joint fittings, epoxy, fasteners, or in any suitable manner. The framework of the prismatic segment 120 can include any suitable combination of struts 124 (integrated or coupled) of any suitable shape (e.g., angled, curved, having a planar surface) located at any suitable portion of the cross-sectional polygonal outline of the prismatic segment 120 (vertex or other location). The base 110 may alternatively comprise any suitable combination of the prismatic segments 120 described above, or may comprise any other suitable surface configured to couple to an ultrasound transducer panel 130.

In other variations, the set of surfaces 122 of the prismatic segment 120 may comprise a set of surfaces 122 angularly displaced about a common axis. The common axis may align with a longitudinal axis of the base, such that the prismatic segment 120 is aligned with the longitudinal axis of the base, or may be displaced from and/or intersect the longitudinal axis of the base. The set of surfaces may be arranged at regular intervals about the common axis, such that the common axis serves as an axis of rotational symmetry; however, the set of surfaces may not be arranged at regular intervals about the common axis. Furthermore, the set of surfaces may be identical or non-identical, planar or non-planar, and/or open or closed.

The ultrasound transducer panels 130 are configured to couple to the base 110 at least at a portion of the surfaces 122, and function to emit and receive ultrasound signals. The ultrasound transducer panels 130 preferably include capacitive micromachined ultrasound transducers (CMUTs), but can additionally or alternatively include any suitable ultrasound transducers. In a first variation, the ultrasound transducer panels 130 comprise CMUT elements, which generate vibrations in a surrounding medium in response to being subjected to an applied alternating (e.g., AC) signal. An applied radio frequency (RF) voltage waveform causes portions (e.g., plates/membranes) of the CMUT elements to vibrate due to storage of elastic energy and release of kinetic energy, which generates an acoustic signal in a surrounding medium. Furthermore, the RF voltage waveform may be added to a constant direct current (DC) baseline voltage. In a complementary manner, incident acoustic waves are detected by the CMUT elements using capacitive detection, which involves modulations in CMUT capacitance and is observed as modulations in the distances between capacitor elements (e.g., plates/membranes) of CMUT elements. The capacitance modulations result in current flow in electronics coupled to the CMUT elements, which can be amplified or conditioned for further processing. To facilitate generation and/or reception of an acoustic signal, the CMUT elements may comprise an insulating material, such as a dielectric material, coupled to a metal electrode. Alternatively, the CMUT elements may be entirely composed of a conductive material or semiconductor. Furthermore, the CMUT elements may comprise transmitter elements that are physically distinct from receiver elements (e.g. transit-time or transmission ultrasound systems)or the CMUT elements may function as both a transmitter and a receiver (e.g. Doppler ultrasound systems). In examples of the first variation, the ultrasound transducer panels 130 comprise CMUT elements such as those described in U.S. Pat. No. 8,399,278, entitled “Capacitive Micromachined Ultrasonic Transducer and Manufacturing Method”, U.S. application Ser. No. 12/727,143, entitled “System and Method for Biasing CMUT Elements”, and U.S. application Ser. No. 13/655,191 entitled “System and Method for Unattended Monitoring of Blood Flow”, which are all incorporated herein in their entirety by this reference.

In a second variation, the ultrasound transducer panels 130 comprise piezoelectric transducer elements, wherein applied electrical pulses are converted to mechanical vibrations that are transmitted to a surrounding medium by the piezoelectric transducer elements. Application of an alternating (e.g., AC) signal induces cyclic polarization of molecules in the transducer material, which results in oscillations that produce acoustic vibrations in a surrounding medium. The piezoelectric transducer elements may further be coupled to acoustic lenses that function to focus emitted acoustic signals. In a complementary manner, incident acoustic signals cause deformations of the piezoelectric transducer, which generates an electric signal that can be measured and analyzed to determine properties of an object reflecting the acoustic signals toward the piezoelectric transducer. The piezoelectric transducer material may be natural (e.g., natural crystaline materials), synthetic, polymeric (e.g., polyvinylidene fluoride), ceramic (e.g., titanates), or any suitable piezoelectric material. In one example, piezoelectric receiver elements of the piezoelectric transducer are physically distinct from piezoelectric transmitter elements of the piezoelectric transducer (e.g. transit-time or transmission ultrasound systems), which can be used to accomplish continuous wave measurements. In another example, each piezoelectric transducer can function as both a transmitter and a receiver, which can be used to accomplish pulsed wave measurements (e.g. Doppler ultrasound systems). In a specific example, the ultrasound transducer panels 130 comprise piezoelectric transducer elements such as those described in U.S. application Ser. No. 13/655,191.

As shown in at least FIGS. 1, 2A, and 2B, the ultrasound transducer panels 130 preferably include at least one planar surface that couples to one or more surfaces 122 of the prismatic segment 120 of the base 110. Alternatively, the ultrasound transducer panels 130 may include a non-planar surface that is configured to conform to a corresponding surface 122 of the base 110. The ultrasound transducer panels 130 are preferably arranged around the prismatic segment 120 of the base 110, and oriented to emit ultrasound signals outwardly (i.e., away from the center of the base 110). The ultrasound transducer panels 130 may alternatively or additionally be configured to emit ultrasound signals inwardly (i.e., toward the center of the base 110). Signals are preferably emitted in a radial direction, with respect to a longitudinal axis of the base 110, but may additionally or alternatively be emitted in any suitable direction (e.g., longitudinally, transversely, circumferentially, etc.).

Each ultrasound transducer panel 130 may be coupled to at least one surface 122 of the prismatic segment 120. For example, as shown in FIGS. 2A and 2B, in the first variation of the prismatic segment 120 that includes solid planar surfaces 122, each ultrasound transducer panel is preferably coupled face-to-face to a respective planar surface 122. As another example, as shown in FIGS. 4A-7B, in the second variation of the prismatic segment 120 that includes surfaces 122 defined by a framework of struts 124, each ultrasound transducer panel 130 preferably couples to the surface 122 of at least one strut 124.

The system 100 may include one ultrasound transducer panel 130 for each surface 122 of the prismatic segment 120 (e.g., ratio of number of panels 130 to number of surfaces 122 of the prismatic segment 120 is 1:1) and the ultrasound transducer panels 130 may be arranged around the entire perimeter of the prismatic segment 120. Alternatively, the system 100 can include multiple ultrasound transducer panels 130 for one or more surfaces 122 (e.g., ratio of number of panels 130 to number of surfaces 122 of the prismatic segment 120 is more than 1:1), or fewer ultrasound transducer panels 130 for one or more surfaces 122 (e.g., ratio of number of panels 130 to number of surfaces 122 of the prismatic segment 120 is less than 1:1) such that the ultrasound transducer panels 130 are arranged around only a portion of the perimeter of the prismatic segment 120. The ultrasound transducer panels 130 can be arranged contiguously on adjacent surfaces 122, or non-contiguously on nonadjacent (e.g., every other, randomly) surfaces 122 of the prismatic segment 120. Furthermore, the system 100 can additionally or alternatively include any suitable electrical components (e.g., CMOS) or other components on one or more of the surfaces of the prismatic segment, such as those described in U.S. Pat. Nos. 7,888,709, 8,309,428, 8,399,278, and 8,315,125, which are incorporated herein by this reference. For instance, the system 100 and/or the set of ultrasound transducer panels 130 may comprise transducer devices with built-in circuits (e.g., technology integrating CMUT devices and CMOS electronic components). One or more of the surfaces 122 of the prismatic segment 120 can additionally or alternatively be empty.

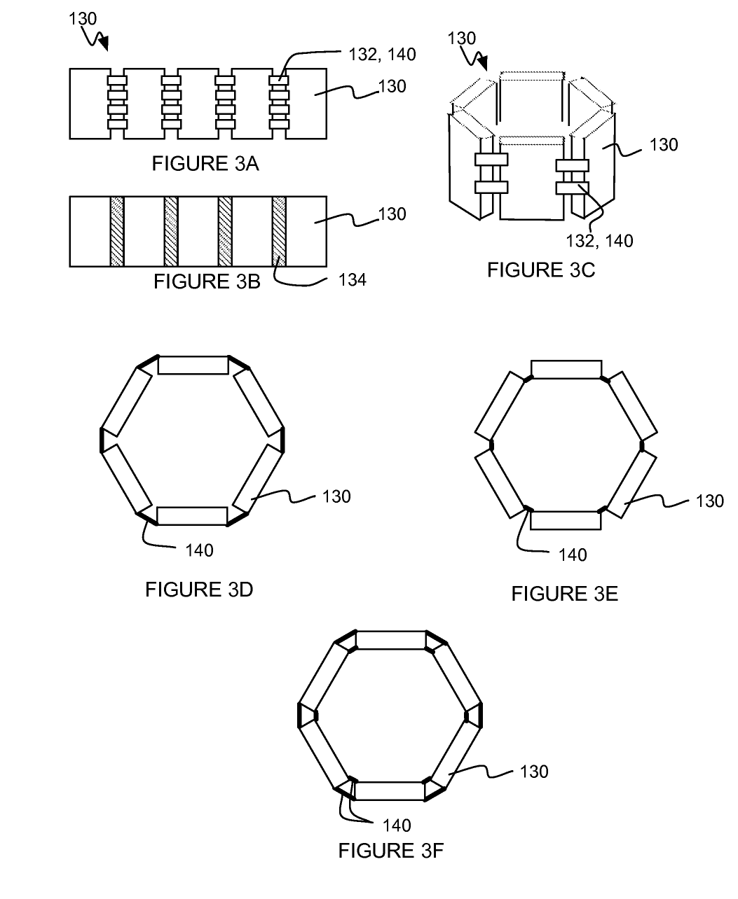

As shown in FIGS. 2A and 2B, in a first variation, the ultrasound transducer panels 130 are substantially separate panels 130 (e.g., the panels are only physically connected by the interconnects 140). In a second variation, the ultrasound transducer panels 130 include additional connections between panels 130 such as flexible bridges 132 connecting a portion of the length of the panels (FIG. 3A) or flexible segments 134 connecting substantially the entire length of the panels (FIG. 3B). In a third variation, the ultrasound transducer panels 130 are arranged in a ring or band. Preferably, the ultrasound transducer panels 130 are integrally formed as a series on a single substrate using micromachining techniques (e.g., deep reactive ion etching; wet etching with tetramethylammonium hydroxide, potassium hydroxide, or ethylene diamine and pyrocatechol), and are configured to include flexible joints for “wrapping” the series of ultrasound transducer panels 130 around the base 110. Alternatively, some or all of the ultrasound transducer panels 130 can be formed individually, individually coupled to a respective side of the prismatic segment 120 of the base 110, and subsequently coupled to one another through the interconnects 140 or in any suitable manner. Furthermore, in some embodiments, the ultrasound transducer panels 130 can additionally or alternatively be formed using any suitable machining techniques (e.g., dicing saw).

The ultrasound transducer panels 130 can be coupled to the base 110 in one or more various manners. In a first coupling variation, at least a portion of the ultrasound transducer panels 130 are mounted to the prismatic segment 120 of the base no with mechanical fasteners, adhesive (e.g., epoxy), or any suitable fasteners. In a second coupling variation, the ultrasound transducer panels 130 are mounted in slots of the prismatic segment 120, or any suitable physical interference mechanisms. In a third coupling variation, a series of ultrasound transducer panels 130 are wrapped around the prismatic segment 120 of the base 110 and held in place by mutual tension (e.g., similar to an elastic band). However, the ultrasound transducer panels 130 can additionally or alternatively be coupled to the base 110 in any suitable manner.

The system 100 preferably further includes at least one interconnect 140, which preferably functions to carry electricity among ultrasound transducer panels 130. As shown in FIGS. 1, 2A, and 2B, each of the interconnects 140 is preferably coupled to two ultrasound transducer panels 130, thereby electrically connecting the two ultrasound transducer panels 130. Each interconnect 140 may alternatively connect a single ultrasound transducer panel to an electronics system, or may electrically connect more than two ultrasound transducer panels 130. Additionally, ultrasound transducer panels electrically connected by an interconnect 140 may otherwise be insulated from each other (e.g., with an air gap or insulating material). Also, as shown in FIGS. 3D-3F, the interconnects 140 may be coupled to a medial surface of an ultrasound transducer panel, to a peripheral surface of an ultrasound transducer panel, or to both a medial surface and a peripheral surface of an ultrasound transducer panel.

In particular, the interconnects 140 are preferably configured to carry electrical signals (e.g., voltage, current) from one ultrasound transducer panel 130 to another ultrasound transducer panel 130. The interconnects 140 are preferably electrically conductive traces formed on a substrate of the ultrasound transducer panels 130, using microfabrication techniques. Example microfabrication techniques include photolithography, deposition, and etching techniques. However, the interconnects 140 can additionally or alternatively be formed on the substrate of the ultrasound transducer panels 130 using any other suitable process. The interconnects 140 preferably comprise a conductive material (e.g., metal) layer coupled to a dielectric material (e.g., contacting a dielectric material or sandwiched between layers of a dielectric material) built onto a surface of a panel. In examples, the dielectric material may be silicon dioxide, silicon nitride, polyimide, parylene, or polydimethylsiloxane. The interconnects 140 may, however, comprise any other suitable material or configuration. Furthermore, the interconnects 140 can additionally or alternatively include cables (e.g., ribbon cables), wires, or any suitable electrically conductive material connected between a set of ultrasound transducer panels 130. Preferably, the interconnects 140 may deform without failure (e.g., fracture), such that the interconnects 140 may be deformed about the prismatic segment 120 of the base 120 while coupling the ultrasound transducer panels 130 to the base. However, the interconnects 140 may not be deformable. In an example comprising non-deformable interconnects 140, the set of ultrasound transducer panels 130 may be coupled to the prismatic segment 130, and electrical connection may be established between two ultrasound transducer panels (e.g., using wire bonding techniques), and then the electrical connection may be stabilized (e.g., encapsulated using epoxy) to form the interconnects 140.

As shown in FIG. 1, the system 100 may further comprise a tracking module 170. The tracking module functions to enable determination of a location of the system 100, which may facilitate applications involving spatial organization or combination of ultrasound data generated by the system 100. The tracking module 170 may comprise a guidewire that passes through a bore 112 of the system 100, such that the guidewire is used to guide the system 100 and to track the system 100 during use. The tracking module 170 may additionally or alternatively comprise an element that can be detected by an external module, such that the location of the system 100 can be identified using the element. The element may comprise a transmitter configured to actively transmit a signal detectable by the external module, or may be a passive element detectable by the external module. The tracking module 170 may alternatively be any other suitable module that enables determination of a location of the system 100 during use.

As a person skilled in the art will recognize from the previous detailed description and from the FIGURES, modifications and changes can be made the described embodiments of the system 100 without departing from the scope of the system 100.

2. Method of Manufacturing an Ultrasound System

As shown in FIG. 8, an embodiment of a method 200 of manufacturing a polygonal ultrasound system includes: forming, on a base, a prismatic segment that defines a set of surfaces in block S210, wrapping a series of ultrasound transducer panels around the prismatic segment in block S220, and coupling the series of ultrasound transducer panels to the prismatic segment in block S230. The method 200 preferably creates an ultrasound system with ultrasound transducer panels approximating a convex and/or concave ultrasound transducer array.

As shown in FIG. 8, Block S210 of the method 200 recites forming, on a base, a prismatic segment that defines a set of surfaces. Block S210 preferably functions to provide a support for the ultrasound transducer panels. The prismatic segment can include surfaces that are solid surfaces, and/or are defined at least in part by a framework. The prismatic segment is preferably formed in one or more of several variations, as described below, but can additionally or alternatively be formed in any suitable manner. In any of these variations, the prismatic segment preferably has a regular hexagonal or dodecagonal cross-section. However, the prismatic segment can have a cross-section of any regular or irregular polygon shape with any suitable number of sides, and/or may comprise curved surfaces.

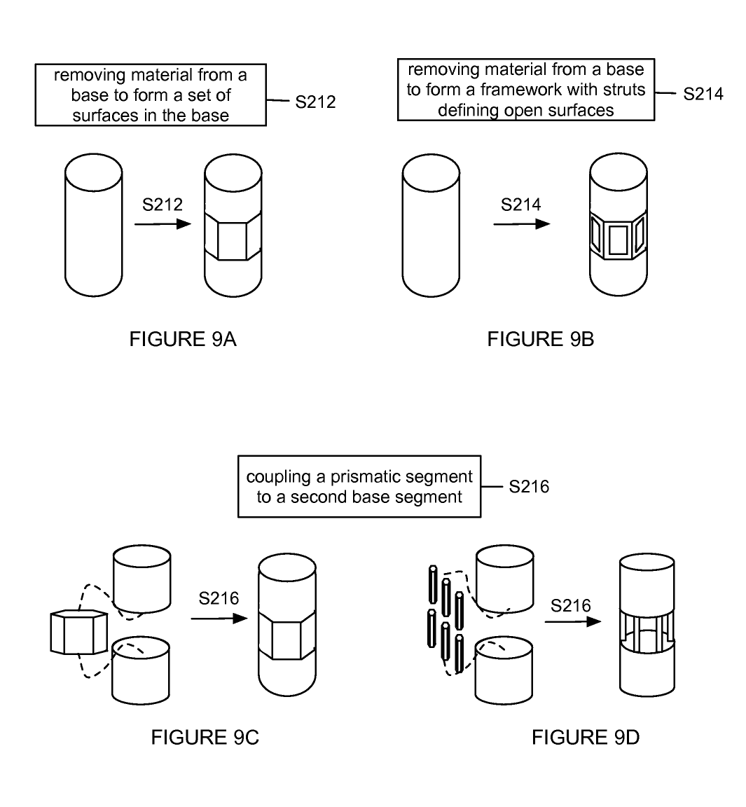

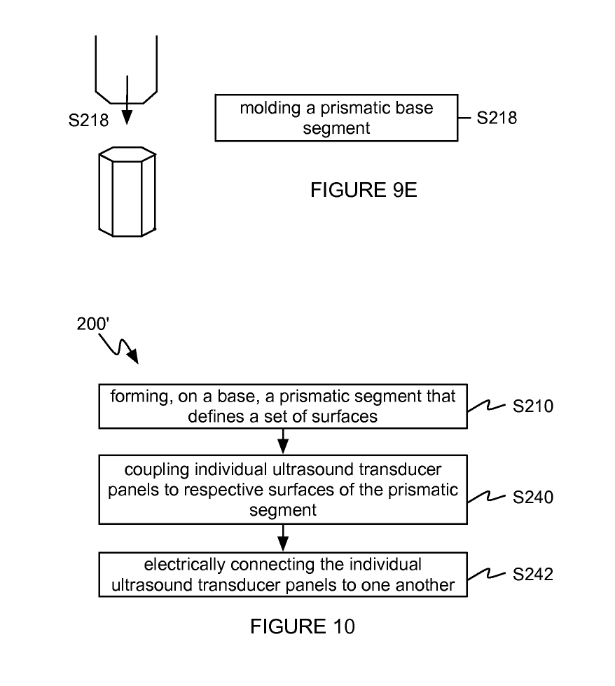

As shown in FIG. 9A, in a first variation, the method 200 includes removing material from a base to form the prismatic segment of the base in block S212. For example, block S212 can include milling, polishing, sanding, grinding, etching, or any suitable material removal process to form the prismatic segment. In an example of the first variation, material may be removed from the base in an incremental manner (e.g., by polishing, by sanding, by grinding) to form surfaces of the prismatic segment. In another example of the first variation, a bulk amount of material may be removed from the base (e.g., by etching or by milling) to form surfaces of the prismatic segment.

As shown in FIG. 9B, in a second variation, the method 200 includes removing material from a base to form a framework with struts defining open surfaces in block S214. For example, an outcome of which is shown in FIG. 4B, block S214 can include enlarging a central bore in the base until the bore is inscribed in the prismatic segment and partially crosses the base, thereby creating struts located at vertices of the prismatic segment. In another example, block S214 can include removing material from an outside surface to form a strut framework (e.g., milling, etching). For instance, a positive or negative etching process may be used to remove material between the struts, with or without a masking step to protect the struts during fabrication. In another example of the second variation, a masking layer may be applied to the strut regions of the base, and the regions between the strut regions may be selectively removed. Removal in this example may comprise processing the material to be removed in order to facilitate removal (e.g., heating, photoactivating, increasing solubility), removing the material, and then removing the masking layer. In yet another example, wherein the base 110 and/or prismatic segment 120 is composed of a silicon material, a Bosch process or a deep-reactive-ion etching (DRIE) process may be used to form the struts. In any of the examples, material may be removed in a manner that merely forms recesses between struts, or may be removed in a manner that forms a continuous cavity surrounded by the struts. Forming the framework with struts in the second variation may alternatively comprise any suitable method of removing material from the base.

As shown in FIGS. 9C and 9D, in a third variation, the method 200 comprises coupling a prismatic segment to a base segment in block S216. The prismatic segment may be coupled between two base segments, or may be coupled to an end of a base segment. For example, block S216 can include separately forming a prismatic base segment (e.g. by machining, molding, 3D printing, etc.) and coupling the prismatic segment to a non-prismatic (e.g., cylindrical, ellipsoidal, amorphous) base segment. In this variation, the prismatic segment can include solid surfaces as shown in FIG. 9C and/or a framework of struts defining open surfaces (e.g., struts on vertices and/or sides of the prismatic segment) as shown in FIG. 9D. Coupling can include mechanical fasteners, adhesive such as epoxy, joint fittings, or any suitable coupling means. Coupling may additionally or alternatively comprise a fusion process (e.g., thermal bonding process) to form a physically coextensive or unitary structure of the base and prismatic segment.

As shown in FIG. 9E, in a fourth variation, the method 200 includes molding a prismatic base segment in block S218. For example, the prismatic base segment can be extruded or casted into a prism. As another example, the prismatic base segment can be formed by 3D printing a base with a prismatic segment. As yet another example, the prismatic base segment can be injection molded or molded in any other suitable manner to form a prismatic base segment. As yet another example, a Czochralski process, a Bridgman-Stockbarger process, or other suitable process may be used to generate a crystalline and/or columnar structure as the prismatic base segment.

As shown in FIG. 8, block S220 in the method 200 recites wrapping a series of ultrasound transducer panels around the prismatic segment. Block S220 preferably functions to approximate a convex and/or concave transducer array. The ultrasound transducer panels are preferably wrapped around the entire perimeter of the prismatic segment, but can alternatively be wrapped around only a portion of the perimeter of the prismatic segment (e.g., only on four out of six surfaces of a hexagonal prismatic segment). Furthermore, the wrapped series of ultrasound transducer panels can include adjacent panels (e.g., on contiguous surfaces of the prismatic segment) and/or nonadjacent panels (e.g., on every other surface of the prismatic segment, random configuration). Each surface of the prismatic segment can be coupled to one or more ultrasound transducer panels and/or any suitable component (e.g., CMOS or other circuitry), or may be empty. In wrapping the ultrasound transducer panels around the prismatic segment, each ultrasound transducer panel preferably interfaces face-to-face with a respective surface of the prismatic segment.

In one variation of block S220, the series of ultrasound transducer panels includes a string of interconnected panels and block S220 includes wrapping the string around the prismatic segment beginning at one end of the string and ending at the other end of the string. In another variation of block S220, the series of ultrasound transducer panels includes a ring of panels and block S220 includes slipping the ring over the prismatic segment from one end of the prismatic segment. However, the ultrasound transducer panels can be wrapped around the prismatic segment of the base in any suitable manner.

As shown in FIG. 8, block S230 in the method 200 recites coupling the wrapped series of ultrasound transducer panels to the prismatic segment. Block S230 preferably functions to secure the ultrasound transducer panels to the base and/or prismatic segment. In a first variation, Block S230 can include utilizing mechanical fasteners, adhesive such as epoxy or any other suitable fastener. In a second variation, block S230 can include inserting the ultrasound transducer panels into slots or any other suitable physical interference mechanisms. In a third variation, block S230 can include allowing the series of ultrasound transducer panels to be held in place by mutual tension (e.g., similar to an elastic band). However, the ultrasound transducer panels can additionally or alternatively be coupled to the base in any suitable manner.

As shown in FIG. 8, the method 200 may further comprise forming a base S205, which functions to provide a substrate coupleable to a prismatic segment, or from which a prismatic segment may be formed. The base may be formed by a molding process (e.g., injection molding), a casting process, a machining process, or a lithographic process. In other variations, S205 may comprise a Czochralski process, a Bridgman-Stockbarger process, or other suitable process to generate a crystalline and/or columnar structure as the base. The method 200 may also further comprise forming a bore within the base S207, which functions to provide a bore within the base that can receive another element. Forming a bore within the base S207 may be performed simultaneously with block S205, or may be performed at any point during the method 200. In one variation, block S207 may comprise simultaneously molding the base and the bore, and in another variation, block S207 may comprise removing material from the base to form the bore. Blocks S205 and S207 may alternatively comprise any other suitable process.

As shown in FIG. 10, in another embodiment of the method 200, instead of blocks S220 and S230, the method 200′ includes coupling individual ultrasound transducer panels to respective surfaces of the prismatic segment in block S240 and/or connecting (e.g., electrically, physically) the individual ultrasound transducer panels to one another in block S242. For example, a bonding wire may be connected from a pad on a first ultrasound transducer panel to a pad on a second ultrasound transducer panel, or pads on individual ultrasound transducer panels may be coupled to a common electrode (e.g., an electrode located in a gap region between neighboring ultrasound transducer panels). In other examples, a flex circuit cable (e.g., a “jumper” cable) may be coupled (e.g., bonded or soldered) to pads on the edges of neighboring ultrasound transducer panels in order to couple the ultrasound transducer panels. The ultrasound transducer panels can be coupled to adjacent and/or nonadjacent surfaces of the prismatic segment. Furthermore, the method can include coupling one or more ultrasound transducer panels and/or any suitable component (e.g., CMOS or other circuitry) to each of at least a portion of the surfaces of the prismatic segment. Some surfaces of the prismatic segment can be coupled to neither an ultrasound transducer panel, nor other component (e.g., can be empty).

The embodiments of the system 100 include every combination of the variations of the base, prismatic segment, ultrasound transducer panels, and interconnect described above. Furthermore, the embodiments of the method 200 include every combination and permutation of the various processes described above. Additionally, the FIGURES illustrate the architecture, functionality and operation of possible implementations of methods according to preferred embodiments, example configurations, and variations thereof. In this regard, each block in the flowchart or block diagrams may represent a module, segment, or portion of code, which comprises one or more executable instructions for implementing the specified logical function(s). It should also be noted that, in some alternative implementations, the functions noted in the block can occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As a person skilled in the art will recognize from the previous detailed description and from the figures and claims, modifications and changes can be made to the preferred embodiments of the invention without departing from the scope of this invention defined in the following claims.

What is claimed is:

1. An ultrasound system comprising:
a base defining a bore;
a prismatic segment, coupled to the base, that defines a set of surfaces surrounding the bore;
a set of ultrasound transducer panels configured to emit ultrasound signals in a radial direction, at least one ultrasound transducer panel in the set of ultrasound transducer panels coupled to at least one surface of the set of surfaces, and
an interconnect coupling a first ultrasound transducer panel in the set of ultrasound transducer panels to a second ultrasound transducer panel in the set of ultrasound transducer panels.

2. The ultrasound system of claim 1, wherein the ultrasound system is configured to be passed through a lumen of a fluid vessel.

3. The ultrasound system of claim 1, wherein a longitudinal axis of the base passes through the bore.

4. The ultrasound system of claim 1, wherein at least one ultrasound transducer panel in the set of ultrasound transducer panels comprises transducer devices with built-in electronic circuits.

5. The ultrasound system of claim 1, wherein the bore is configured to receive at least one of a catheter, a guidewire, and a fluid.

6. The ultrasound system of claim 1, wherein the prismatic segment is physically coextensive with the base.

7. The ultrasound system of claim 1, wherein the set of surfaces comprises identical surfaces angularly displaced about a common axis.

8. The ultrasound system of claim 1, wherein the set of surfaces comprises planar surfaces, such that a transverse cross section through the set of surfaces defines an outline of a polygon.

9. The ultrasound system of claim 8, wherein the polygon is at least one of a hexagon and a dodecahedron.

10. The ultrasound system of claim 1, wherein the prismatic segment comprises a framework of struts, each strut in the framework of struts located proximal to a vertex of the prismatic segment.

11. The ultrasound system of claim 1, wherein at least one ultrasound transducer panel in the set of ultrasound transducer panels conforms to at least one surface of the set of surfaces.

12. The ultrasound system of claim 1, wherein the set of ultrasound transducer panels is configured to emit ultrasound signals in a radially outward direction.

13. The ultrasound system of claim 12, wherein the set of ultrasound transducer panels is further configured to emit ultrasound signals in a radially inward direction.

14. The ultrasound system of claim 1, wherein the set of ultrasound transducer panels comprises at least one of CMUT elements and piezoelectric transducer elements.

15. The ultrasound system of claim 1, wherein the interconnect is an electrical interconnect that electrically connects the first ultrasound transducer panel to the second ultrasound transducer panel.

16. The ultrasound system of claim 1, wherein the interconnect facilitates coupling of the first ultrasound transducer panel and the second ultrasound transducer panel to the prismatic segment.

17. The ultrasound system of claim 1, wherein the interconnect is coupled to at least one of a medial surface and a peripheral surface of an ultrasound transducer panel.

18. The ultrasound system of claim 1, further comprising a tracking module.

19. A method of manufacturing an ultrasound system, the method comprising:
forming a base;
forming a bore within the base;
forming, on the base, a prismatic segment that defines a set of surfaces surrounding the bore, wherein forming comprises coupling the prismatic segment to the base to form a physically coextensive structure,
wherein at least one of forming the bore and forming the prismatic segment comprises removing material from the base;
wrapping a series of ultrasound transducer panels around the prismatic segment; and
coupling at least one ultrasound transducer panel in the series of ultrasound transducer panels to the prismatic segment.

20. The method of claim 19, further comprising electrically connecting a first ultrasound transducer panel to a second ultrasound transducer panel, and coupling at least one of the first ultrasound transducer panel and the second ultrasound transducer panel to the prismatic segment.
